(19) United States
(12) Patent Application Publication
(10) Pub. No.: US 2014/0263872 A1
(43) Pub. Date: Sep. 18, 2014

(54) Apparatus For Use With Decorative Lighting

(71) Applicant: Shaffarne, LLC, Henderson, NV (US)

(72) Inventors: Nathan Benjamin Shaffer, Henderson, NV (US); Shamin Rivers Arne, Henderson, NV (US)

(73) Assignee: Shaffarne, LLC, Henderson, NV (US)

(21) Appl. No.: 13/969,347

(22) Filed: Aug. 16, 2013

Related U.S. Application Data
(60) Provisional application No. 61/851,910, filed on Mar. 15, 2013.

(51) Int. Cl. F21V 21/14; F16M 13/02

(52) U.S. Cl. CPC F21V 21/14; F16M 13/022
USPC 248/70; 248/224.7

(57) ABSTRACT

An apparatus for use with decorative lights is provided. The apparatus includes a mounting bracket having a rear wall, a side wall, and at least one lip. The rear wall, the side wall, and the at least one lip form a mounting bracket channel. The apparatus further includes a stud having a base sized to fit in the mounting bracket channel and to enable the stud to slidably couple with the mounting bracket, the stud further having a stud channel. The apparatus further includes a stud cap configured to removably couple with the stud, at least partially secure the decorative lights within the stud channel, and position the stud with respect to the mounting bracket channel.

### BACKGROUND

The field of the invention relates generally to decorative lighting, and more particularly to an apparatus for use with decorative lighting, especially Christmas and string lights.

As a replacement for dangerous candles, holiday lighting, particular Christmas lights, have grown in popularity since their introduction in the early 20^{th} century. The lights themselves as well as their applications have become more sophisticated in recent years. However, despite the advances, lights must still be put up and taken down with each holiday season—mostly because year-round residential Christmas light displays are not socially acceptable.

Lights are often installed on roof perimeters by attaching light wiring to fascia boards using staples or other fasteners. The fasteners present a challenge by requiring hands-on access to sometimes tall roofs on ladders. Accordingly, an apparatus is desired that enables a person to selectively display or conceal Christmas lights without using known fasteners and, perhaps, from a safe distance.

### BRIEF DESCRIPTION

An apparatus for use with decorative lights is provided. The apparatus includes a mounting bracket having a rear wall, a side wall, and at least one lip. The rear wall, the side wall, and the at least one lip form a mounting bracket channel. The apparatus further includes a stud having a base sized to fit in the mounting bracket channel and to enable the stud to slidably couple with the mounting bracket, the stud further having a stud channel. The apparatus further includes a stud cap configured to removably couple with the stud, at least partially secure the decorative lights within the stud channel, and position the stud with respect to the mounting bracket channel.

### BRIEF DESCRIPTION OF THE DRAWINGS

FIG. 1 is a perspective view of an apparatus for use with decorative lights.

FIG. 2 is an alternative perspective view of the apparatus of FIG. 1.

FIG. 3 illustrates an exemplary use of the apparatus of FIG. 1.

### DETAILED DESCRIPTION

Christmas lights can be difficult to hang on a house, particularly on fascia boards on eaves. The subject matter described herein facilitates a simple installation of an apparatus for use with Christmas lights for concealing and revealing Christmas lights. Once installed, the apparatus enables the lights to be raised behind the fascia board and concealed thereby. The lights may also be lowered or positioned at a desired position using the apparatus for operation of the lights. For example, the lights may be lowered so that the lights are visible, or the lights may be kept behind the fascia board to create a backlit effect on the fascia board. The apparatus may be operated from a distance, usually the ground, so that a ladder is not required. Using a pole as described herein, the lights may be raised and secured in place or lowered for display. Thus, seasonal Christmas light displays are simplified by storing and concealing the lights until they are selectively revealed.

FIGS. 1 and 2 illustrate an exemplary apparatus 100 for use with a lighting system. Typical environments or fields of use for the apparatus 100 are varied. A non-limiting example environment, which will be used throughout this specification and is illustrated in FIG. 3, includes a roof overhang for use with decorative or holiday lights 300 that are string lights (i.e., that have multiple light bulb fixtures 305 coupled by wiring 310). As explained in more detail herein, the apparatus 100 may be installed and used, in the example environment, on a fascia board 315 inside an open eave on the roof overhang. Other uses and environments are contemplated.

The apparatus 100 is an assembly that includes a mounting bracket 102, a slidable stud 104, and a stud cap 106. The apparatus 100 may also include a stud cap driver 108. The mounting bracket 102 may include one or more apertures 110 for use with one or more fasteners (not shown). In some embodiments, the one or more apertures 110 are at least partially recessed such that fasteners, such as nails or screws, do not protrude into the mounting bracket and interfere with operation of the slidable stud 104.

The mounting bracket 102 includes a rear wall 112, a side wall 114, a first lip 116, and a second lip 118. The side wall 114 is joined to the rear wall 112 such that at least one opening 120 is created. The first and second lip 116 and 118 are each disposed longitudinally along the side wall 114, opposite the rear wall 112. The lips 116 and 118 are spaced a first distance 122 apart from the rear wall 112 and are spaced a second distance 124 apart from each other. A channel 125 is created along the longitudinal axis of the mounting bracket 102 by the rear wall 122, the side wall 114, and the lips 116 and 118.

The mounting bracket 102 may be approximately five inches long or similarly sized such that lights are concealed when raised. The mounting bracket 102 may be five inches long because that is the common distance between a rafter and a bottom of the fascia board.

In the exemplary embodiment, the slidable stud 104 includes a base 126, a channel 128, and a stud fastener 130. The base 126 is sized to fit in the opening 120 of the mounting bracket 102 and such that the base 126 may slide into and between the lips 116 and 118 and the rear wall 112. The base 126 may include a raised portion 129 that is sized to fit between the first lip 116 and the second lip 118. The channel 128 is sized to accommodate at least a portion of the decorative lights. In the exemplary embodiment, the channel 128 is sized to accommodate the wiring that connects two or more lights in a string.

The stud cap 106 may be configured to removably couple with the slidable stud 104. As described in more detail herein, the stud cap 106 may include a stud cap fastener 131 that mates with the stud fastener 130. In the exemplary embodiment, the stud fastener 130 and the stud cap fastener may include threads such that the stud cap 106 may be screwed onto the slidable stud 104.

In the exemplary embodiment, the stud cap 106 includes a spacer 132 that protrudes along the longitudinal axis of the stud cap 106. Alternatively, the stud cap 106 may not include the spacer 132. The spacer 132 is positioned at approximately the center point of a circle created by the stud cap fastener 131. As the stud cap 106 is tightened onto the slidable stud 104, the stud fastener 130 may be partially drawn in upon itself. That is, the arms of the stud fastener 130 that define the channel 128 may be brought together as a result of the force applied by the stud cap 106. If the arms of the stud fastener 130 are drawn together, they are thereby drawn away from the stud cap fastener 131 and therefore may become freer to move. The undesirable result is that the stud cap 106 may “slip” as the stud cap 106 becomes tighter on the slidable stud 104. The spacer 132 facilitates keeping the arms of the stud fastener 130 disposed adjacent to the stud cap fastener 131. That is, the spacer 132 helps to keep the arms of the stud fastener 130 apart as the stud cap 106 is tightened. The spacer 132 may also contact the wiring of the lighting to help compress the wiring against the base 126 and/or the raised portion 129 in order to immobilize the wiring.

The stud cap 106 has a cap geometry 133 that may be configured to mate with an internal stud cap driver geometry 134. In the exemplary embodiment, the stud cap driver geometry 134 is configured such that it has twice as many sides as the stud cap geometry 133, enabling the stud cap driver 108 to be removably coupled with the stud cap 106 in a number of orientations or positions, wherein the number of positions is greater than the number of sides on the stud cap 106. Such a configuration enables the stud cap driver 108 to be more easily mated to the stud cap 106 without requiring more precise alignment.

Once mated, the stud cap driver 108 is configured to rotate the stud cap 106. As the stud cap 106 is tightened onto the slidable stud 104, the portion of the lighting positioned in the channel 128 is secured against the base 126 and/or the raised portion 129. The compression caused by the stud cap 106 facilitates holding the lighting, such as wiring, in place. Moreover, when the slidable stud 104 is disposed inside the mounting bracket 102, compression caused by tightening or screwing the stud cap 106 to the slidable stud 104 causes the base 126 to be compressed against or secured to the lips 116 and 118 such that the slidable stud 104 is held in place. Thus, the stud cap 106 causes the lighting and the slidable stud 104 to be retained.

In the exemplary embodiment, the stud cap driver 108 includes one or more guides 136. The guides 136 may be spaced and sized to guide components of the decorative lights. For example, the guides 136 may be spaced such that the wiring of string lights is positioned therebetween. Using the stud cap driver 108, the wiring, and therefore the lights, may be lifted into position. The stud cap driver 108 may be coupled to a shaft or pole (not shown) via a shaft connector 138. The shaft, which may be telescoping, enables a user to raise and lower the stud cap driver 108 among other tasks. The shaft connector 138 may be threaded or have other known connectors for connecting to poles.

Reference is made to FIG. 3, which illustrates an exemplary usage of the apparatus 100. During operation, the mounting bracket 102 may be secured to a support element, such as a fascia board, using screws through the apertures 110. Alternatively, adhesive may be used to adhere the mounting bracket 102 to the support element. The mounting bracket 102 is typically installed with the opening 120 pointing up. Next, the slidable stud 104 may be inserted into and slid down the mounting bracket 102. The wiring of string lights, such as Christmas lights, may be placed in the channel 128. Notably, the mounting bracket 102 is typically mounted vertically, and thus the channel 128 may be oriented in the direction of the wiring, i.e., horizontally.

For lighting strings that are too large to be placed in the channel 128 (e.g., rope lighting) or in circumstances where it is desired that the string itself be located below the bottom of the mounting bracket 102, a hook may be placed in the channel 128. The hook may have a first portion that fits in the channel 128. The first portion may be coupled to a shaft portion that is sized to position a second portion below the bottom of the mounting bracket 102 and/or the bottom of a fascia board such that the second portion is not concealed by the fascia board when the slidable stud 104 is lowered. The lighting string, such as rope lighting, may be removably coupled to the second portion. When raised by the slidable stud 104, the fascia board may conceal the second portion of the hook and therefore the lighting.

In circumstances where the eave is not open and/or where the back (i.e., house-facing side) of the fascia board is not accessible, a false fascia board may be mounted to the real fascia board. The false fascia board may be painted to match the fascia board. A distance between the false fascia board and the real fascia board enables one or more apparatus 100 to be mounted to the back of the false fascia board (i.e., between the false and real fascia boards). Thus, the apparatus 100 may be installed even where the rear of a fascia board is not ordinarily accessible.

With the wiring inserted into the channel 128, the stud cap 106 may be hand tightened onto the slidable stud 104. The slidable stud 104 may be slid into any desired position and further tightened to secure the slidable stud 104 in place against the mounting bracket 102. Because the slidable stud 104 may rest against the side wall 114 at the bottom of the mounting bracket 102, it is not necessary to fully tighten (i.e., such that neither the wiring nor the slidable stud 104 is freely moving) the stud cap 106. At this stage, the apparatus 100 is installed. With the slidable stud 104 at the bottom, the lighting may be at its lowest point and therefore best displayed from behind the fascia board. Multiple apparatus 100 may be installed in series to suspend a length of lighting. Tension on wiring between apparatus 100 may be adjusted by tightening the stud cap 106 to alter the amount of sag or droop in wiring between apparatus 100.

Later, perhaps after the holiday season, when it is desirable to conceal the lighting, the apparatus 100 may be adjusted. To raise the lighting, the slidable stud 104 may be raised inside the mounting bracket 102 and then secured by tightening the stud cap 106. Again, the stud cap 106 may be hand tightened. Because the apparatus 100 is typically installed under an eave, a ladder is often required to manipulate the apparatus 100. However, the stud cap driver 108, with a shaft attached, may enable manipulation of the apparatus 100 from a distance. For example, the user may stand on the ground while raising the stud cap driver 108 to the stud cap 106.

For icicle-like lighting strings that have dangling substrings, hooks may be placed on fascia boards to support the dangling substrings. To conceal the icicle lights, the string may first be raised on the mounting brackets 102. The dangling substrings may then be raised such that the end of the substring opposite the main string is at least partially supported by one or more hooks such that the fascia board at least partially conceals the dangling substring.

The user sufficiently aligns the geometries 133 and 134 of the stud cap driver 108 and the stud cap 106 and removably couples them together. Using the stud cap driver 108, the user lifts the stud cap 106 and the slidable stud 104 into a desired position, generally such that the lights are hidden in the eaves. Now, using the shaft attached to the stud cap driver 108, the user may rotate the stud cap 106 using the stud cap driver 108.

Once installed, lights can be easily lowered using the system. By hand or using the stud cap driver 108, the stud cap 106 may be loosened, causing the slidable stud 104 to lower due to gravity. The slidable stud 104 may be lowered to any desired position. Thus, the lights may be brought into viewable position, e.g., for the holiday season. Alternatively, lights may be used in a raised position to create a backlighting effect with the fascia board.

In the exemplary embodiment, the stud fastener 130 and corresponding geometry (e.g., threads in the stud cap 106) enable the stud cap 106 to be tightened with a minimum of turns. For example, the user may only need to rotate the stud cap driver 108 a quarter-turn in order to fully tighten the stud cap 106. This minimal rotation greatly simplifies operation from a distance using the stud cap driver 108.

In some embodiments, the mounting bracket 102 includes at least one gear rack disposed longitudinally on the interior of the lips 116 and 118 and the rear wall 112 (i.e., on the interior of the side wall 114). The slidable stud 104 may include a flexible pawl that enables the slidable stud 104 to be ratcheted in one direction along the longitudinal axis of the mounting bracket 102 (e.g., like a zip tie). The pawl or the at least one gear rack may be moved in order to release the slidable stud 104 to move freely.

In some embodiments, a spring may oppose the movement of the slidable stud 104 in a direction parallel to the longitudinal axis of the mounting bracket 102. The slidable stud 104 may then be ratcheted or locked into place until released. When released, the slidable stud 104 is moved by the spring to a pre-determined position. In such embodiments, the opening 120 may be closed to prevent the slidable stud 104 from becoming disengaged with the mounting bracket 102.

In some embodiments, the mounting bracket 102 includes at least one gear rack disposed longitudinally on the interior of the lips 116 and 118 and the rear wall 112 (i.e., on the interior of the side wall 114). A motor, such as a servo, coupled to the slidable stud 104, turns a gear rotatably coupled to the slidable stud 104 that facilitates movement of the slidable stud 104 with respect to the mounting bracket 102. In other words, the slidable stud 104 may be moved up and down the mounting bracket 102 using an electric motor. Power for the electric motor may come from the lighting wiring via an insulator piercing connector, light bulb fixture, or inductively. Alternatively, or additionally, power for the electric motor may come from a power source separate from the lighting. The motor may be controlled externally by digital or analog controls whether electrically or wirelessly coupled. For example, a wireless signal could cause motors in a plurality of mounting brackets 102 to raise or lower in unison to raise or lower a lighting string. Such automation may be used for seasonal movement of lights or for orchestration during a light performance.

The subject matter described herein enables efficient and cost-effective concealment of Christmas lights and other lights or lighting systems. The apparatus and methods described herein enable a person to install the apparatus and Christmas lights and selectively conceal or reveal the lights with respect to a fascia board or other surface or support. As an advantage over known systems, the apparatus described herein enable lights to be stored and concealed after the holiday system more or less in place, and then to be lowered for display. The raising and lowering mechanics facilitated by the apparatus are superior to known systems because they are simple and may be reliably executed by a user from a distance.

The logic flows depicted in the figures or described herein do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included. The subject matter described herein relates to raising and lowering lights and may be implemented in a variety of ways for application with different lights and environments. For example, while a particular sliding apparatus for raising and lowering string lights has been described in detail, other apparatus for accomplishing the same are contemplated. An apparatus may raise and lower string or Christmas lights with relation to an eave or covering by moving the lights vertically, by rotating the lights into position as on a hinge coupled to the rear of a fascia board, or by any other means. A plurality of apparatus, whether sliding or hinged or otherwise, may be used to couple to the wiring of the lights and/or light bulb housings. By coupling the wiring to the support element (typically a fascia board) at intervals, distances and locations selected by the user, the wiring can better follow the contours of an eave. This is an advantage over some known apparatus (see, e.g., U.S. Pat. No. 5,311,414 to Branham) that couple a length of string lighting (e.g., one or more feet in length) to a support element and therefore are not suitable for short eaves or eaves with many intersections and angles. Also unlike the apparatus in Branham, the subject matter described herein may leave the lighting exposed such that it may be operated in a raised condition to create a backlighting effect behind a fascia board.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An apparatus for use with decorative lights, the apparatus comprising:
a mounting bracket having a rear wall, a side wall, and at least one lip, the rear wall, the side wall, and the at least one lip forming a mounting bracket channel;
a stud having a base sized to fit in the mounting bracket channel and to enable the stud to slidably couple with the mounting bracket, the stud further having a stud channel; and
a stud cap configured to:
removably couple with the stud;
at least partially secure the decorative lights within the stud channel; and
position the stud with respect to the mounting bracket channel.

2. An apparatus in accordance with claim 1, further comprising a stud cap driver that is configured to removably couple to the stud cap and facilitate rotation of the stud cap.

3. An apparatus in accordance with claim 2, wherein the stud cap driver is configured to couple with a shaft such that the stud cap driver may be remotely rotated.

4. An apparatus in accordance with claim 1, wherein said stud cap comprises a spacer that is configured to extend into the stud channel when the stud cap is coupled with the stud.

5. An apparatus in accordance with claim 1, wherein the mounting bracket is approximately five inches in length.

6. An apparatus in accordance with claim 1, wherein the stud cap is further configured to screw onto the stud.

7. An apparatus in accordance with claim 1, wherein the stud channel is configured to accommodate a wiring of the decorative lighting.

8. An assembly for use with decorative lights, the assembly comprising:
an apparatus comprising:
a mounting bracket having a rear wall, a side wall, and at least one lip, the rear wall, the side wall, and the at least one lip forming a mounting bracket channel;
a stud having a base sized to fit in the mounting bracket channel and to enable the stud to slidably couple with the mounting bracket, the stud further having a stud channel; and
a stud cap configured to:
removably couple with the stud;
at least partially secure the decorative lights within the stud channel; and
position the stud with respect to the mounting bracket channel; and
a stud cap driver that is configured to removably couple to the stud cap and facilitate rotation of the stud cap.

9. An assembly in accordance with claim 8, wherein the stud cap driver is configured to couple with a shaft such that the stud cap driver may be remotely rotated.

10. An assembly in accordance with claim 8, wherein said stud cap comprises a spacer that is configured to extend into the stud channel when the stud cap is coupled with the stud.

11. An assembly in accordance with claim 8, wherein the stud cap is further configured to screw onto the stud.

12. An apparatus for use with decorative lights, the apparatus comprising:
a mounting bracket having a rear wall, a side wall, and at least one lip, the rear wall, the side wall, and the at least one lip forming a mounting bracket channel;
a stud having a base sized to fit in the mounting bracket channel and to enable the stud to slidably couple with the mounting bracket, the stud further having a stud fastener and a stud channel; and
a stud cap configured to:
removably couple with the stud by screwing onto the stud fastener;
at least partially secure the decorative lights within the stud channel; and
position the stud with respect to the mounting bracket channel.

13. An apparatus in accordance with claim 12, wherein said stud cap comprises a spacer that is configured to extend into the stud channel when the stud cap is coupled with the stud.
